(19) United States
(12) Patent Application Publication
(10) Pub. No.: US 2023/0343508 A1
(43) Pub. Date: Oct. 26, 2023

(54) COIL COMPONENT, CIRCUIT BOARD ARRANGEMENT, ELECTRONIC DEVICE AND METHOD OF MANUFACTURING COIL COMPONENT

(71) Applicant: TAIYO YUDEN CO., LTD., Tokyo (JP)

(72) Inventors: Hideaki HOSHINO, Takasaki-shi (JP); Kenichiro NOGI, Takasaki-shi (JP)

(21) Appl. No.: 18/303,497

(22) Filed: Apr. 19, 2023

(30) Foreign Application Priority Data
Apr. 25, 2022 (JP) 2022-071279

(51) Int. Cl. H01F 27/29; H01F 27/24; H01F 27/06; H01F 41/04

(52) U.S. Cl. CPC H01F 27/292; H01F 27/24; H01F 27/06; H01F 41/041; H01F 2027/065

(57) ABSTRACT

A coil component includes a base body formed of metal magnetic particles; a conductor provided inside and/or on the base body; and an external electrode electrically connected to the conductor. The external electrode includes first, second, and third electrode layers. The first electrode layer contains a metal material and is provided in a first predetermined area of a first face of the base body. The second electrode layer is provided in a second predetermined area of a second face and contains a metal material at a metal filling rate lower than that of the first electrode layer. The third electrode layer covers the first electrode layer and the second electrode layer and extends over the first predetermined area of the first face and the second predetermined area of the second face of the base body.

### FIELD OF THE INVENTION

This invention relates to coil components, circuit board arrangements, electronic devices, and methods of manufacturing the coil components.

### DESCRIPTION OF THE RELATED ART

Electronic devices, such as communication devices, have been enhanced in performance, and the number of electronic components used in the electronic device has increased in proportion to the enhanced performance of the electronic device. However, the size of the electronic device is often limited, and therefore it is necessary to suppress increasing the size of the electronic device due to the increase in the number of the electronic components. This may be achieved by replacing the existing parts with smaller parts. For this reason, electronic components are required to have both enhanced performance and smaller size. This trend is also regarded as important from the viewpoint of SDGs (Sustainable Development Goals).

Downsizing of coil components is attempted from various technical aspects. Use of a magnetic material instead of a common material (i.e., replacement of the common material with the magnetic material) is one of the technologies for downsizing. Ferrite magnetic material is used in many coil components, but a metallic magnetic material may be used instead of the ferrite magnetic when, for example, a current equal to or higher than 1A is applied to a coil component. Metallic magnetic material has higher magnetic saturation characteristics than ferrite magnetic material, and the volume of the magnetic material can be reduced on the basis of the difference in magnetic saturation characteristics.

Also, sputtering is used to reduce the thickness of each of external electrodes of a coil component. When the coil component has six faces (e.g., the coil component has a rectangular parallelepiped shape), each of the external electrodes may be provided on only one face of the six faces of the coil component rather than on five faces of the coil component, in order to achieve further downsizing of the coil component. For example, JP-A-2009-267146 discloses a coil component in which each of the external electrodes is provided on only one surface of a six-sided body of the coil component. In this specification, if each external electrode is provided on only one face of a six-sided body, such configuration is called “single-side external electrode.”

### SUMMARY OF THE INVENTION

However, there are some restrictions on the external electrodes. For example, because a coil component is required to have low DC resistance, it may be necessary to make the external electrodes from a metal having a low resistance, and it may be necessary for each of the external electrodes to have a certain thickness.one—

Further, in order to ensure appropriate mounting of the external electrodes onto a substrate or a board, it is difficult to eliminate plating from the external electrodes. Stress generated in or around each of the external electrodes can become a serious problem in the plating if each of the external electrodes is provided on only one face of the coil component (e.g., the coil component of JP-A-2009-267146) although such problem does not occur if each of the external electrodes is provided on five faces of the coil component.

As described above, in the case where the number of faces on which the external electrodes are provided is reduced, external electrodes capable of dealing with stress are needed.

An objective of the present invention is to provide a coil component having external electrodes capable of suppressing DC resistance and coping with stress.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the objective of the present invention, as embodied and broadly described, in one aspect, the present disclosure provides a coil component which includes a magnetic base body, a conductor and external electrodes. The magnetic base body is formed by bonding metal magnetic particles. The magnetic base body has a first face and a second face that is immediately adjacent to the first face. The conductor is provided inside and/or on a surface of the magnetic base body. The external electrodes are electrically connected to the conductor. Each of the external electrodes includes a first electrode layer, a second electrode layer, and a third electrode layer. The first electrode layer contains a metal material, and is provided in a first predetermined area of the first face close to the second face of the magnetic base body. The second electrode layer is provided in a second predetermined area of the second face close to the first face, and contains a metal material with a metal filling rate (percentage) lower than that of the first electrode layer. The third electrode layer is configured to cover the first electrode layer and the second electrode layer, and extend over the first predetermined area of the first face and the second predetermined area of the second face of the magnetic base body.

The first face of the magnetic base body may face a board (substrate) when the coil component is mounted on the board.

An imaginary line may be defined at an interface between the first face and the second face, and the second electrode layer may have a smaller dimension in a direction parallel to the imaginary line than in a direction perpendicular to the first face.

A portion of the second electrode layer may cover a portion of the first electrode layer on the first face.

Ends of the conductor may be connected to the first electrode layers of the external electrodes such that the conductor is electrically connected to the external electrodes.

The second electrode layer of each external electrode may have a metal filling rate of 60% or less.

The first electrode layer of each external electrode may have a metal filling rate of 70% or more.

According to another aspect of the present invention, there is provided a circuit board arrangement that includes the above-described coil component, and a board on which the coil component is mounted.

According to still another aspect of the present invention, there is provided an electronic device that includes the above-described circuit board arrangement.

According to yet another aspect of the present invention, there is provided a method of manufacturing the above-described component. The method includes applying a first conductive paste, which contains a metal material and a non-metal material, on the first predetermined area of the first face of the magnetic base body. The first conductive paste will become the first electrode layer of each external electrode. The method also includes applying a second conductive paste, which contains a metal material and a non-metal material and has a metal filling rate higher than that of the first conductive paste, on the second predetermined area of the second face of the magnetic base body. The second conductive paste will become the second electrode layer of each external electrode. The method also includes sintering the first conductive paste and the second conductive paste to form the first electrode layer and the second electrode layer. The method also includes forming the third electrode layer covering the first electrode layer and the second electrode layer of each external electrode.

The method may further include planarizing the first conductive paste applied to the first face of the base body by applying pressure toward the first face of the base body.

The above-mentioned forming the third electrode layer may include forming the third electrode layer by plating.

According to the present invention, the coil component has external electrodes that can reduce DC resistance and can be resistant to stress.

### BRIEF DESCRIPTION OF THE DRAWINGS

FIG. 1 is a perspective view of a coil component according to an embodiment of the present invention.

FIG. 2 is a front view of the coil component shown in FIG. 1.

FIG. 3 is an end view of the coil component shown in FIG. 1.

FIG. 4 is a bottom view of the coil component shown in FIG. 1.

FIG. 5 is a cross-sectional view of the coil component shown in FIG. 1, taken along the line V-V in FIG. 4.

FIG. 6 illustrates a modification to external electrodes.

FIG. 7 is an enlarged view of a portion of the external electrode shown in FIG. 6.

FIG. 8A to FIG. 8D is a series of diagrams that illustrate a manufacturing process of a coil component according to a first comparative example.

FIG. 9A illustrates a front view of the first comparative example shown in FIG. 8D.

FIG. 9B illustrates an end view of the first comparative example of FIG. 9A.

FIG. 10A to FIG. 10D is a series of diagrams showing a manufacturing process of the external electrodes in a coil component according to a second comparative example.

FIG. 11A illustrates a front view of the second comparative example shown in FIG. 10D.

FIG. 11B illustrates an end view of the second comparative example of FIG. 11A.

FIG. 12 is an enlarged cross-sectional view of an external electrode that extends onto an upper surface of a magnetic base body.

FIG. 13A to FIG. 13C is a series of diagrams illustrating a step of applying a first conductive paste.

FIG. 14A to FIG. 14E are a series of diagrams illustrating a step of applying a second conductive paste.

FIG. 15A and FIG. 15B show a step of sintering the conductive pastes.

FIG. 16A and FIG. 16B show a step of forming third electrode layers.

FIG. 17 is a perspective view of a coil component according to a modified embodiment.

FIG. 18 is an enlarged end view of the coil component shown in FIG. 17.

FIG. 19 is a table showing results of electrical tests that were conducted on actual coil components when the coil components had different metal filling rates in a first electrode layer.

FIG. 20 is a table showing results of strength tests that were conducted on actual coil components when the coil components had different metal filling rates in a second electrode layer.

### DETAILED DESCRIPTION OF EMBODIMENTS

The following is a detailed description of embodiments of the invention with reference to the accompanying drawings. The following embodiments are not intended to limit the invention, and not all of the combinations of features described in the embodiments are essential for the configuration of the invention. The configuration of the embodiments may be modified or changed if necessary depending on the specifications of the device to which the invention is applied and various conditions (conditions of use, environment of use, etc.).

The technical scope of the invention is defined by the claims and is not limited by the following individual embodiments. The drawings used in the following description may differ in scale and shape from the actual structure in order to make each configuration easier to understand. Parts, elements, and components shown in one of the drawings may be referred to in the description of other drawings.

### Structure of Coil Component

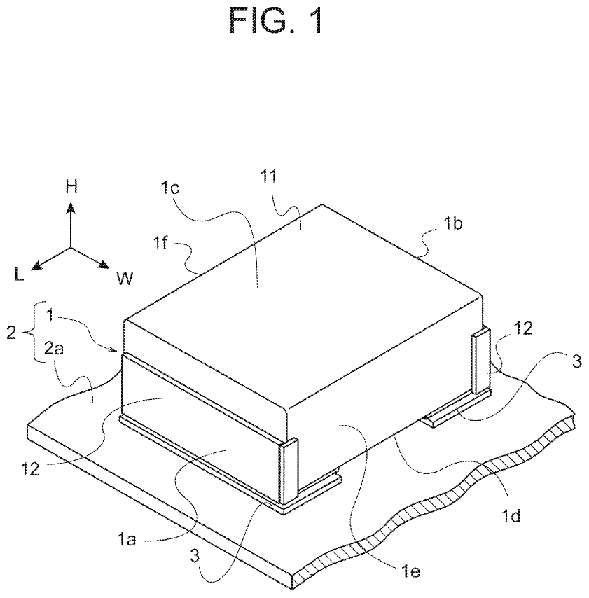

FIG. 1 is a perspective view showing a coil component 1 according to an embodiment of the present invention.

The coil component 1 is mounted on a board 2a. The board 2a has two land portions 3 thereon. The board 2a may be referred to as a substrate or a plate member. The coil component 1 includes a magnetic base body 11, and two external electrodes 12 on the magnetic base body 11. The coil component 1 is mounted on the board 2a as the external electrodes 12 are joined to the land portions 3 by soldering. A circuit board arrangement 2 according to an embodiment of the present invention includes the coil component 1 and the board 2a on which the coil component 1 is mounted. The circuit board arrangement 2 is used in various electronic devices, such as an electric component of an automobile, a server, a board computer (tablet computer), and other electronic devices. The external electrodes 12 may be referred to as outer electrodes.

In this specification, unless the context requires otherwise, the description of direction is based on the “L-axis”, “W-axis”, and “H-axis” directions in FIG. 1. The L-axis is referred to as the length direction, the W-axis is referred to as the width direction, and the H-axis is referred to as the height direction. The height direction may also be referred to as the thickness direction.

The coil component 1 has a rectangular parallelepiped shape. That is, the coil component 1 has a first end face (left face) 1a and a second end face (right face) 1b at opposite ends in the length direction, a first main face (top face) 1c and a second main face (bottom face) 1d at opposite ends in the height direction, and a front face 1e and a rear face 1f at opposite ends in the width direction. The rectangular parallelepiped shape has eight corners, and twelve ridges (edges) that connect the eight corners.

The dimensions of the sides of the rectangular parallelepiped shape of the coil component 1 are as follows: the length is in a range of, for example, 1 mm to 5 mm, the width is in a range of, for example, 0.5 mm to 4.5 mm, and the height is in a range of, for example, 0.4 mm to 3.5 mm. The height of the coil component 1 is smaller than the length of the coil component 1. The height of the coil component 1 is also smaller than the width of the coil component 1.

Each of the first end face 1a, the second end face 1b, the first main face 1c, the second main face 1d, the front face 1e, and the rear face 1f of the coil component 1 may be a flat surface or a curved surface. The eight corners of the coil component 1 may be rounded, and the twelve ridges of the coil component 1 may be rounded.

It should be noted a portion of each of the first end face 1a, second end face 1b, first main face 1c, second main face 1d, front face 1e, and rear face 1f of the coil component 1 may be curved and/or the corners and ridges of the coil component 1 may be rounded, but such a shape is also referred to as a rectangular parallelepiped shape in this specification. In other words, when “rectangular parallelepiped” and “rectangular” are used herein, they do not mean rectangular parallelepiped and rectangular in the strict mathematical sense.

The coil component 1 also includes a conductor in the magnetic base body 11. It should be noted that the conductor may be wound around the magnetic base body 11. The magnetic base body 11 may be called a drum core if the conductor is wound around the magnetic base body 11. Thus, the conductor may be provided on the surface of the magnetic base body 11.

The magnetic base body 11 is an insulator that contains a magnetic material. The magnetic base body 11 may contain 95 wt % or more of a metallic magnetic material, 1 wt % or more of a resin, and other components. The metal magnetic material is metal magnetic particles containing Fe, Ni, or Co, and the metal magnetic particle may contain any of Si, Cr, Al, B, and P in addition to Fe, Ni, or Co, or may contain a plurality of Si, Cr, Al, B, and P in addition to Fe, Ni, or Co. The magnetic base body 11 may contain an oxide.

The magnetic base body 11 may be formed of a combination (mixture) of multiple kinds of metal magnetic particles, and may include a ceramic material and a glass material. The magnetic base body 11 may be formed by bonding metal magnetic particles with a resin, or may be formed by bonding metal magnetic particles with an oxide, for example. The metal magnetic particles may be subjected to an insulation treatment, or insulation of the base body 11 may be ensured by the presence of a resin or an oxide.

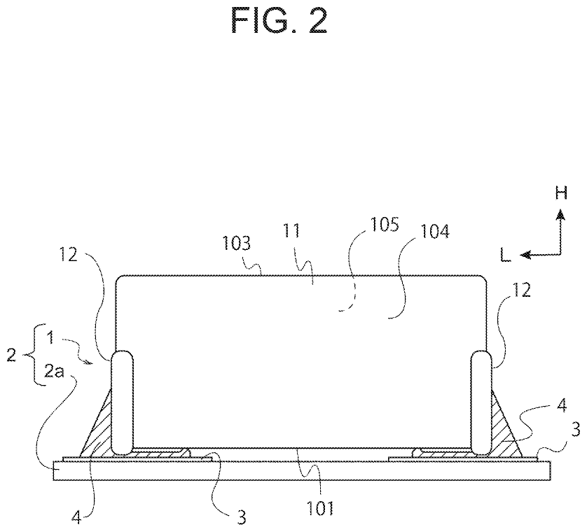

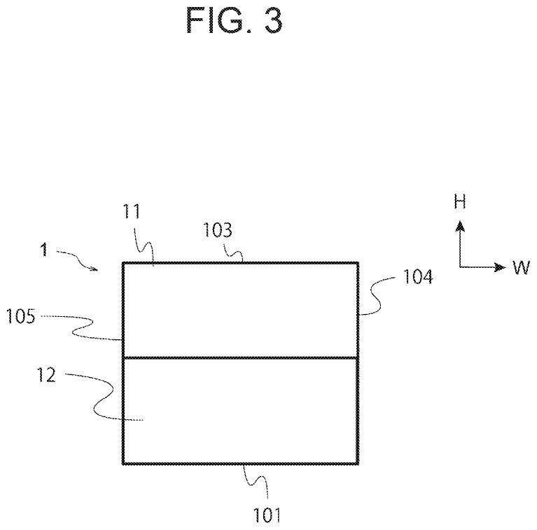

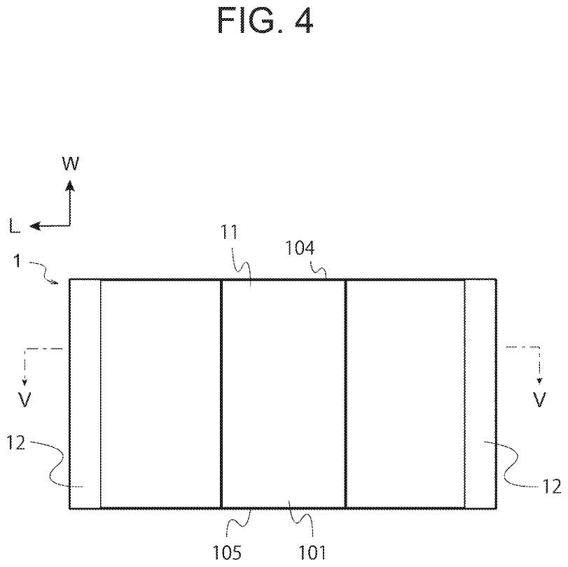

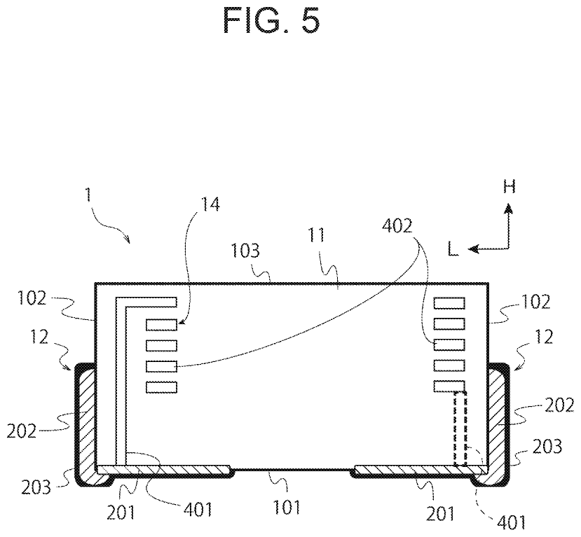

FIG. 2 is a front view of the coil component 1 shown in FIG. 1. FIG. 3 is an end view (left view or right view) of the coil component 1 shown in FIG. 1. FIG. 4 is a bottom view of the coil component 1 shown in FIG. 1. FIG. 5 is a cross-sectional view of the coil component 1 shown in FIG. 1, taken along the line V-V in FIG. 4. Hereinafter, description will be given with reference to FIG. 1 to FIG. 5.

The magnetic base body 11 has a rectangular parallelepiped shape. The magnetic base body 11 has two end faces (left end face and right end face) 102 at opposite ends in the length direction. The magnetic base body 11 has a bottom face 101 at one end in the height direction, and an upper face 103 at the other end in the height direction. The magnetic base body 11 has a front face 104 and a rear face 105 at opposite ends in the width direction. The bottom face 101 is a surface facing the board 2a when the coil component 1 is mounted on the board 2a.

The conductor 14 is made of a metal material having excellent conductivity. The metal material for the conductors 14 includes, for example, at least one of Ag, Cu, Al, and Ni, or includes an alloy containing any of Ag, Cu, Al, and Ni. An insulating coating may be provided on the surface of the conductor 14. The sole conductor 14 is provided for the sole magnetic base body 11 in this embodiment. It should be noted, however, that a plurality of conductors 14 may be provided for the sole magnetic base body 11.

The conductor 14 shown in FIG. 5 includes a winding part 402 formed by a conductive wire, and two lead portions 401 extending from the winding part 402. The two lead portions 401 are connected to the two external electrodes 12, respectively. As understood from FIG. 5, the conductive wire of the winding part 14a is wound in a direction generally parallel to the top face 101 and bottom face 103 of the magnetic base body 11 with a winding axis perpendicular to the top face 101 and bottom face 103. Thus, the conductor 14 (or the winding part 14a) has a so-called horizontal winding structure (a horizontally-aligned winding structure with a vertical winding axis). It should be noted, however, that the conductor 14 may have a so-called vertical winding structure (a vertically-aligned winding structure with a horizontal winding axis), and the conductive wire is wound in parallel to the end faces 102 of the base body 11.

The coil component 1 has the left external electrode 12 on the first end face 1a (or the left end face 102), and the right external electrode 12 on the second end face 1b (or the right end face 102). The left external electrode 12 is provided on a predetermined area of the left end face 102 from the lower end of the left end face 102 (i.e., the left external electrode 12 extends upward to a certain height from the lower end of the left end face 102 but does not reach the upper end of the of the left end face 102) and on a predetermined area of the bottom surface 101 from the lower edge (ridge) of the left end face 102 (i.e., the left external electrode 12 also extends to the right along the bottom face 101 but does not reach a center of the bottom face 101). Similarly, the right external electrode 12 is provided on a predetermined area of the right end face 102 from the lower end of the right end face 102 and on a predetermined area of the bottom face 101 from the lower edge (ridge) of the right end face 102. The left end face 102 is a surface immediately adjacent to the left edge of the bottom face 101, and the right end face 102 is a surface immediately adjacent to the right edge of the bottom face 101. The left and right end faces 101 extend in a direction perpendicular to the board 2a when the coil component 1 is mounted on the board 2a. The left external electrode 12 is connected to the left land portion 3 on the board 2a by the left solder 4, and the right external electrode 12 is connected to the right land portion 3 on the board 2a by the right solder 4. As shown in FIG. 2, the solder 4 wets up to the external electrode 12 provided on each of the end faces 102, and forms a so-called fillet. By forming the fillet, the coil component 1 is connected to the board 2a with adequate fixing strength. Because the coil component 1 has the fillet, the external electrodes 12 of the coil component 1 have a stronger fixing strength to the board 2a than a coil component having single-side external electrodes.

Each of the external electrodes 12 extends over a portion of the front surface 104 from the end surface 102 and over a portion of the rear surface 105 from the end surface 102. As shown in FIG. 1, each of the external electrodes 12 does not extend on the entire front surface 104 (i.e., the external electrode 12 extends in a small area along the ridge of the end surface 102, like a thin and narrow strip), and does not extend on the entire rear surface 105 (i.e., the external electrode 12 extends in a small area along the ridge of the end surface 102, like a thin and narrow strip).

The left external electrode 12 extends over a portion of the left end surface 102 from the left edge of the bottom surface 101 and does not reach the upper surface 103. The right external electrode 12 extends over a portion of the right end surface 102 from the right edge of the bottom surface 101 and does not reach the upper surface 103. Thus, the right and left external electrodes 12 are spaced from the upper surface 103 in the height direction of the coil component 1.

In the coil component 1, the magnetic base body 11 and the conductor 14 are integrally formed by, for example, lamination.

The magnetic base body 11 is made of a composite magnetic material that contains one or more kinds of metal magnetic particles and a binder resin. The magnetic base body 11 may contain one or more kinds of metal magnetic particles, and the magnetic base body 11 may be formed by bonding the metal magnetic particles to each other by an oxide film on the surface of each metal magnetic particle. The metal magnetic particle may have Fe or Ni, as its major component. Specifically, the metal magnetic particle may include FeSiCr, FeSiAl, FeSiCrB, Fe—Ni, or Fe. Alternatively, a combination of at least two of FeSiCr, FeSiAl, FeSiCrB, Fe—Ni, and Fe may be used as the metal magnetic particles. The metal magnetic particles may include, for example, Si, Bi, or the like.

The shape of the metal magnetic particles is not particularly limited, but is preferably a spherical shape or a generally spherical shape or close to a spherical shape. The size of the particles is preferably 1 μm to 20 μm in average particle diameter. The metal magnetic particles may be subjected to an insulating treatment.

The binder resin binds the metal magnetic particles to each other. The binder resin is, for example, a thermosetting resin having excellent insulating properties. The material of the magnetic base body 11 is not limited to that explicitly mentioned in this specification, i.e., any material which is known as a suitable material of the base body of the coil component may be used.

The conductor 14 is made of a metallic material having excellent conductivity. The metallic material for the conductor 14 contains, for example, at least one of Cu, Al, Ni, and Ag, or contains an alloy containing at least one of Cu, Al, Ni, and Ag. The conductor 14 may include an oxide as part of the metallic material.

In the formation by lamination of the coil component 1, a plurality of magnetic sheets made of the above-described composite magnetic material are prepared, and a planar conductor pattern for forming the conductor 14 is formed on the surface of each of the magnetic sheets by, for example, printing or the like. A method other than printing, such as plating, vapor deposition, or transfer of paste, may be used for forming the conductor pattern.

In order to form vias that connect the conductor patterns to each other, holes are formed in the magnetic sheets, and the holes are filled with the conductor material. The vias are made, for example, by printing or filling. Printing of the vias may be performed simultaneously with printing of the conductor pattern or may be performed individually. A method other than printing, such as plating, vapor deposition, or transfer of paste, may also be used for forming the vias.

Thereafter, these magnetic sheets, each of which is provided with the conductor pattern and the vias, are stacked, with another magnetic sheet being placed on top of the stack as an uppermost layer of the magnetic base body 11 and another magnetic sheet being placed below the stack as a lowermost layer of the magnetic base body 11. The uppermost layer of the magnetic base body 11 has no conductor pattern and no vias. The lowermost layer of the magnetic base body 11 has no conductor pattern and no vias. Then, the stacked magnetic sheets are pressed to obtain a laminate. The laminate is cut into a plurality of pieces, and these pieces are subjected to heat treatment to obtain a plurality of magnetic base bodies 11 each of which has a built-in conductor 14. In the heat treatment of the individual pieces derived from the laminate, the resin may be removed by thermal decomposition, and the metal magnetic particles may be oxidized as the heat treatment is carried out at a temperature between 600 degrees C. and 850 degrees C.

Thereafter, two external electrodes 12 are formed on each of the magnetic base bodies 11 such that the two external electrodes 12 are connected to the two lead portions 401 of the conductor 14, respectively.

### Structure of External Electrode

As shown in FIG. 5, each of the external electrodes 12 includes a first electrode layer 201 provided on the bottom face 101, a second electrode layer 202 provided on the end face 102, and a third electrode layer 203 covering the first electrode layer 201 and the second electrode layer 202.

Each of the first electrode layer 201 and the second electrode layer 202 is a conductive layer including a metal material and a non-metal material. The first electrode layer 201 includes a metal material in an 70 wt % or more, and the second electrode layer 202 includes a metal material in an 60 wt % or less. The metallic material is a metallic grain containing at least one of Ag, Cu, and Ni. The non-metallic material may contain a ceramic material, and/or a glass material. Each of the first electrode layer 201 and the second electrode layer 202 includes void portions.

Since the metal filling rate (percentage) of the second electrode layer 202 is lower than that of the first electrode layer 201, the first electrode layer 201 has a lower DC resistance, and less stress is generated in the second electrode layer 202. That is, the first electrode layer 201 has a lower DC resistance than the second electrode layer 202 because the first electrode layer 201 has a higher metal filling rate than the second electrode layer 202. Because the second electrode layer 202 has a lower metal filling rate than the first electrode layer 201, the second electrode layer 202 has more resin and voids than the first electrode layer 201. Because of the resin and voids, less stress is generated in the second electrode layer 202.

The third electrode layer 203 is made of a metal material having excellent conductivity. For example, Cu and/or Ag may be used as the metallic material, and Ni, Pd, and Sn may be additionally used. The third electrode layer 203 is formed in a multilayer structure. Specifically, a plurality of layers whose main component is the above-mentioned metal(s) are layered, and/or a plurality of layers whose main component is a partial alloy of the above-mentioned metal(s) are layered. The third electrode layer 203 is formed by, for example, plating, coating of the metal material, sputtering, or vapor deposition.

The external electrodes 12 are provided on the surface of the magnetic base body 11. The external electrodes 12 are electrically conductive at positions connected to the lead portions 401 of the conductor 14. The electrical connection between each of the lead portions 401 of the conductor 14 and the corresponding external electrode 12 is made via a portion of the layer including Sn.

As illustrated in FIG. 5, in this embodiment, the connection between the conductor 14 and each of the external electrodes 12 is the connection between the lead portion 401 and the first electrode layer 201 on the bottom surface 101, and electrical conduction is established by this connection. Because the left lead portion 401 is connected to the left first electrode layer 201, and the right lead portion 401 is connected to the right first electrode layer 201, DC resistance between the coil component 1 and the substrate 2a is suppressed.

Each of the external electrodes 12 may include an underlying electrode layer (not shown) between the first electrode layer 201 and the magnetic base body 11, and/or between the second electrode layer 202 and the magnetic base body 11. The underlying electrode layer is made from a metallic material such as Ag, Cu, Ti, and/or Ni. The underlying electrode layer is provided on the surface of the magnetic base body 11 by plating, coating of the metallic material, sputtering, or vapor deposition. The underlying electrode layer may have a thickness of 1 μm or less. Some portions of the underlying electrode layer may be separated from other portions of the underlying electrode layer.

As shown in FIG. 5, the first electrode layer 201 extends over a portion of the bottom surface 101 that is close to the end surface 102. The second electrode layer 202 extends over a portion of the end surface 102 close to the bottom surface 101. The second electrode layer 202 does not reach the upper surface 103. If the third electrode layer 203 is formed by plating, for example, plating elongation that extends toward the upper surface 103 is suppressed because the upper end of the second electrode layer 202 is separated from the upper surface 103.

Since each of the end surfaces 102 extends in a direction perpendicular to the surface of the substrate 2a when mounting the coil component 1 onto the substrate 2a, each of the second electrode layers 202 also extends in a direction perpendicular to the surface of the substrate 2a. Therefore, stress applied to each of the external electrodes 12 from the fillet of the solder 4 is relieved.

The dimension of the second electrode layer 202 in the height direction H is smaller than the dimension of the second electrode layer 202 in the width direction W. That is, the dimension of the second electrode layer 202 in a direction perpendicular to the bottom face 101 is smaller than the dimension of the second electrode layer 202 in a direction parallel to the bottom face 101. The smaller dimension of the second electrode layer 202 in the height direction H further relaxes the stress received by the external electrode 12 from the fillet of the solder 4. It should be noted that the dimension of the second electrode layer 202 in the height direction H is a dimension perpendicular to the bottom face 101, and the dimension of the second electrode layer 202 in the width direction W is a dimension in a direction parallel to a line (ridge) defined at an interface between the first face and the second face of the base body 11.

A lower portion of the second electrode layer 202 reaches the bottom face 101, and covers a portion of the first electrode layer 201 in the vicinity of the ridge between the bottom face 101 and the end face 102. When the second electrode layer 202 covers a portion of the first electrode layer 201 in the vicinity of the ridge, the stress on the first electrode layer 201 is relaxed. It should be noted that the second electrode layer 202 may be in contact with the first electrode layer 201 without covering the first electrode layer 201, or the second electrode layer 202 may be spaced apart from the first electrode layer 201.

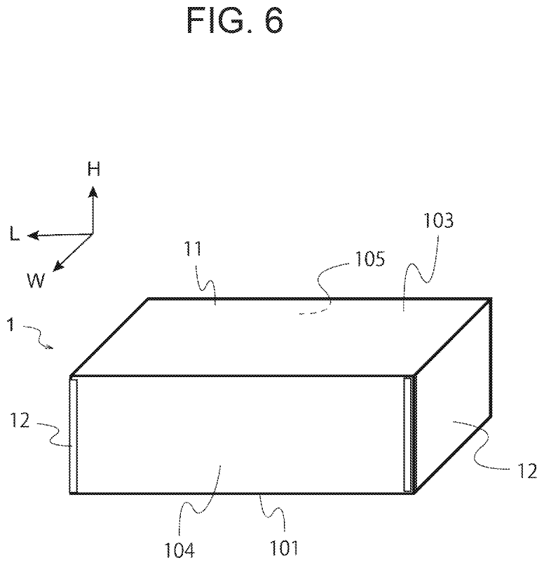

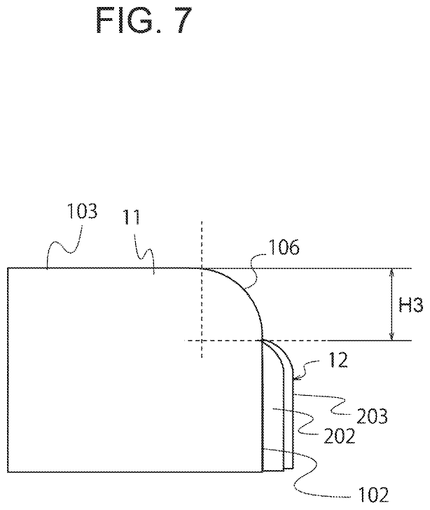

FIG. 6 illustrates a modification to the external electrodes 12. FIG. 7 is an enlarged view of one of the external electrodes 12 shown in FIG. 6.

Each of the external electrodes 12 of FIG. 6 extends over the entire end face 102 of the magnetic base body 11. The external electrode 12 of FIG. 6 extends over a portion of the bottom face 101, a portion of the front face 104, and a portion of the rear face 105, but does not reach the upper face 103.

As shown in FIG. 7, the second electrode layer 202 extends over the entire end face 102 but is spaced apart from the top face 103 by height H3. Specifically, the upper end of the second electrode layer 202 does not reach the top face 103 but reaches the lower end of the curved surface portion 106 that defines the ridge between the end face 102 and the upper face 103. Therefore, plating elongation and the like in the upward direction (direction H) are suppressed, and the upper end of the third electrode layer 203 is also separated from the upper face 103. By suppressing the plating elongation, the occurrence of eddy current loss is suppressed when the relative magnetic permeability of the magnetic material is low (e.g., when the relative magnetic permeability is smaller than 40). Further, even when the coil component 1 is small (e.g., one side of the coil component 1 is smaller than 0.5 mm), generation of eddy current loss is suppressed.

In the modified example shown in FIG. 6 and FIG. 7, the DC resistance of each of the external electrodes 12 is suppressed, and the stress received by each of the external electrodes 12 from the fillet of the solder 4 is relieved.

The presence and thickness of each of the layers that form each of the external electrodes 12 may be confirmed by observing the cross section of the external electrode 12 by SEM (Scanning Electron Microscope) or the like. For example, as the cross section of each of the external electrodes 12 is observed by the SEM, it is possible to confirm the presence of the respective contact surfaces that distinguish the magnetic base body 11, the conductors 14, the first electrode layer 201, the second electrode layer 202, and the third electrode layer 203 from each other. In addition, the presence of metals, carbons, and oxygens is confirmed to distinguish the respective layers as components are analyzed by the SEM. Also, the metal packing rate (metal filling rate) in each of the layers is obtained as a result of component analysis with the SEM.

### Method of Manufacturing External Electrodes

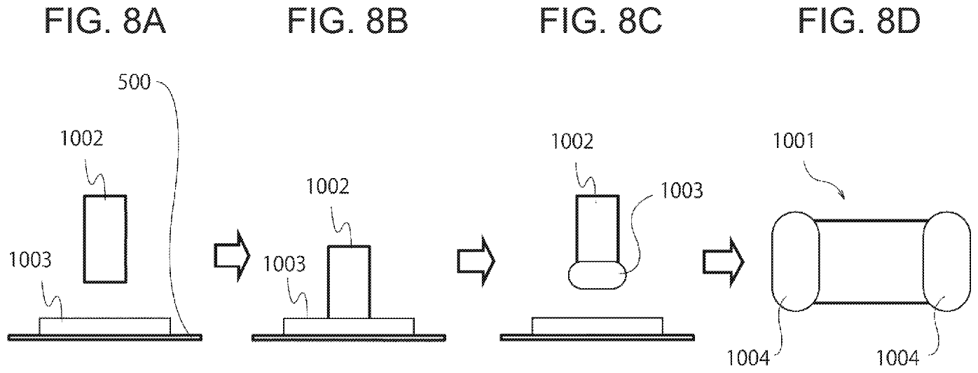

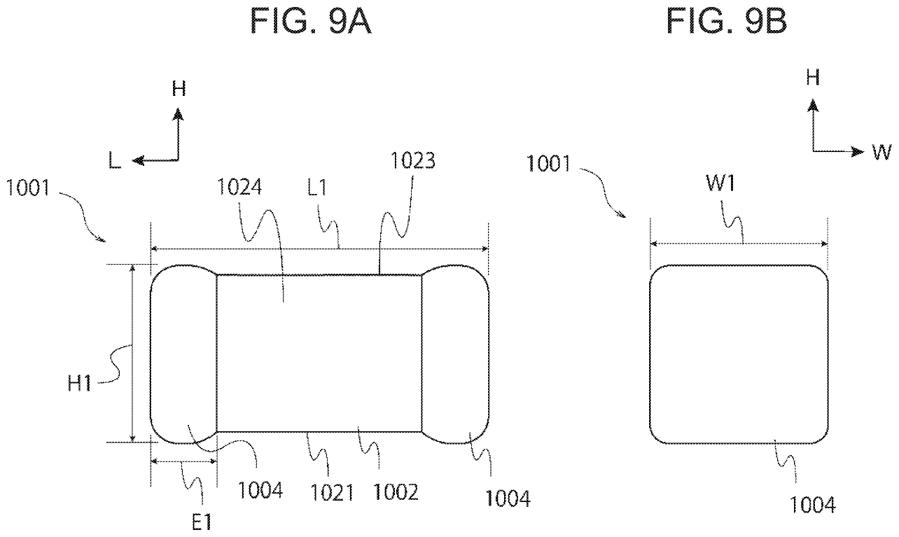

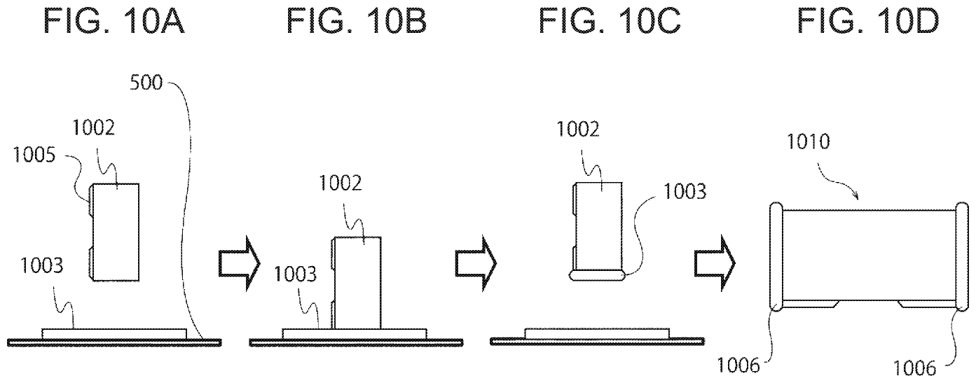

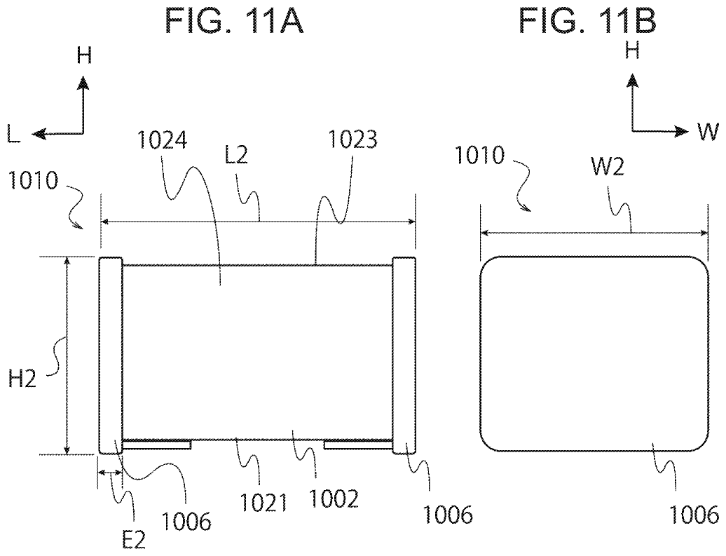

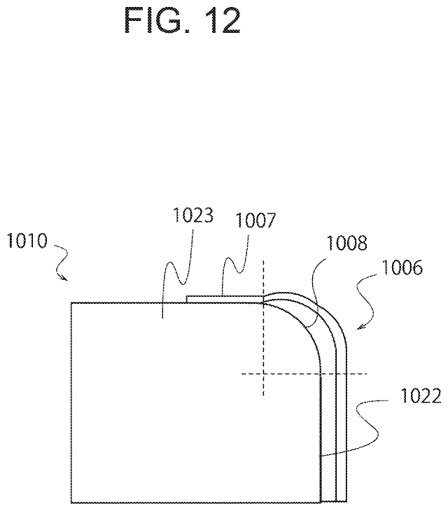

Before describing a method of manufacturing the external electrodes 12 of the coil component 1 shown in FIG. 1 to FIG. 5, two comparative examples will be described below. A first comparative example will be described with reference to FIG. 8A to FIG. 8D, and FIG. 9A to FIG. 9B. A second comparative example will be described with reference to FIG. 10A to FIG. 10D, FIG. 11A to FIG. 11B, and FIG. 12.

FIG. 8A to FIG. 8D is a series of diagrams showing the manufacturing process of external electrodes 1004 of a coil component 1001 of the first comparative example. FIG. 9A and FIG. 9B show the structure of the first comparative example. FIG. 9A is a front view of the coil component 1001 (first comparative example), and FIG. 9B is an end view of the first coil component 1001. The coil component 1001 includes a magnetic base body 1002 that has six surfaces.

Each of the external electrodes 1004 of the coil component 1001 of the first comparative example is formed on five faces of the six faces of the magnetic basic body 1002. Specifically, the left external electrode 1004 is formed on the left end face, the front face, the rear face, the top face, and the bottom face of the base body 1002, and the right external electrode 1004 is formed on the right end face, the front face, the rear face, the top surface, and the bottom face of the base body 1002. This type of external electrode is referred to as a five-sided external electrode 1004. The external electrodes 1004 are made by a known dipping method.

In the step shown in FIG. 8A, a conductive paste 1003 is applied on a flat plate 500. In the dipping step shown in FIG. 8B, one end face of the magnetic base body 1002 is dipped in the conductive paste 1003. As the magnetic base body 1002 is pulled up from the plate 500 (FIG. 8C), one end face of the magnetic base body 1002 is covered with the conductive paste 1003. The same process is performed to the other end face of the magnetic base body 1002. Then, the conductive paste 1003 on the two end faces of the base body 1001 is sintered to obtain the coil component 1001 having the five-sided external electrodes 1004 at both end faces of the magnetic base body 1002 (FIG. 8D).

In such a dipping process, the conductive paste 1003 is inevitably attached to an upper face 1023, a front face 1024, and a rear face of the magnetic base body 1002 which do not need the external electrodes 1004 formed thereon, so that the external electrodes 1004 are unintentionally formed on the upper face 1023, the front face 1024, and the rear face of the magnetic base body 1002. As a consequence, the dimension H1 in the height direction and the dimension W1 in the width direction of the external electrodes 1004 become larger than the external dimension of the magnetic base body 1002 due to a partial moon shape of the conductive paste 1003 around the circumference of each end face (i.e., the conductive paste 1003 is bulged and takes an arc shape around the circumference of each end face).

In addition, the dimension E1 of the external electrode 1004 in the length direction is large, and the dimension L1 of the coil component 1001 in the length direction is larger than the external dimension of the magnetic base body 1002. Therefore, in the first comparative example, downsizing of the coil component 1001 is hindered by the five-sided external electrodes 1004. In addition, if the coil component 1001 having the five-sided external electrodes 1004 is mounted on the board 2a, and the board 2a bends, stress is generated in or around the external electrodes 1004 by the bending movement (deflection) of the board 2a, and the stress is transmitted to the magnetic base body 1002 without the stress being weakened by the external electrodes 1004. As a result, cracks or the like may occur in the magnetic base body 1002.

FIG. 10A to FIG. 10D is a series of diagrams showing the manufacturing process of external electrodes 1006 of a coil component 1010 of the second comparative example. FIG. 11A and FIG. 11B show the structure of the second comparative example. FIG. 11A shows a front view of the coil component 1010, and FIG. 11B shows an end view of the coil component 1010. Similar reference numerals are used in the first and second comparative examples to designate similar portions, parts, and elements.

The coil component 1010 of the second comparative example has two external electrodes 1006. The left external electrode 1006 is formed on the left end face and the bottom face 1021 of the base body 1002, and the right external electrode 1006 is formed on the right end face and the bottom face 1021 of the base body 1002. This type of external electrode is referred to as a two-sided external electrode 1006. The external electrodes 1006 on the right and left end faces of the base body 1002 are made by a dipping method. The external electrodes 1006 on the bottom face 1021 of the base body 1002 are referred to as bottom electrode portions 1005.

In the manufacturing process of the external electrodes 1006 of the coil component 1010, the two bottom electrode portions 1005 are formed on the bottom face 1021 of the magnetic base body 1002 in advance (i.e., prior to the dipping process of making the external electrodes 1006 on the end faces of the magnetic base body 1002). The conductive paste 1003 is applied on the flat plate 500 (FIG. 10A), and one end face of the magnetic base body 1002 is dipped in the conductive paste 1003 (FIG. 10B). It should be noted, however, that the conductive paste 1003 spreads thinner on the flat plate 500 than the manufacturing method of the first comparative example, or the dipping depth of the end face of the magnetic base body 1002 into the conductive paste 1003 is smaller than that of the manufacturing method of the first comparative example.

Consequently, in the second comparative example, the conductive paste 1003 adheres to the magnetic base body 1002 at a thickness smaller than that in the first comparative example (FIG. 10C). The same dipping process is performed on the other end face of the magnetic base body 1002. Then, the conductive paste 1003 is sintered to obtain the coil component 1010 having the two-side external electrodes 1006 at both ends of the magnetic base body 1002 (FIG. 10D).

The dimension E2 of the external electrode 1006 of the coil component 1010 of the second comparative example in the length direction L, which is formed of the conductive paste 1003 (FIG. 10C), is smaller than the dimension E1 of the external electrode 1004 of the first comparative example in the length direction L. Therefore, the electrode area on the upper face 1023 and the front face 1024 of the second comparative example is smaller than that of the first comparative example. It should be noted, however, that the external electrode 1006 is inevitably formed on the upper face 1023 and the front face 1024, which is not required in an ideal structure. Since the external electrodes 1006 reach the upper surface 1023 of the magnetic base body 1002, there is a possibility that cracks or the like may occur in the magnetic base body 1002 due to stress exerted on the external electrode 1006 that is caused by deflection of the board 2a. Thus, the first comparative example and the second comparative example may suffer cracks or the like.

Since the thickness E2 of the external electrode 1006 of the second comparative example at each of the ends of the magnetic base body 1002 is smaller than the thickness E1 of the external electrode 1004 of the first comparative example, the dimension L2 of the coil component 1010 in the length direction is smaller than the dimension L1 of the first comparative example. However, in the second comparative example, the dimension H2 in the height direction and the dimension W2 in the width direction of the external electrode 1006 are larger than the external dimension of the magnetic base body 1002 due to the partial moon shape, around the circumference of each end face, of the conductive paste 1003 attached to each of the end faces of the magnetic base body 1002. This is similar to the first comparative example. Therefore, downsizing of the coil component 1010 of the second comparative example is hindered by the external electrodes 1006.

FIG. 12 is an enlarged cross-sectional view of the external electrode 1006 that extends to the upper surface 1023 of the magnetic base body 1002.

In the second comparative example, the upper end portion of the external electrode 1006 covers the curved surface portion 1008 of the magnetic base body 1002. The curved surface portion 1008 forms the ridge between the upper surface 1023 and the end surface 1022 of the magnetic base body 1002. Therefore, in the second comparative example, an elongation of plating 1007 is generated along the upper surface 1023, and an eddy current loss is generated.

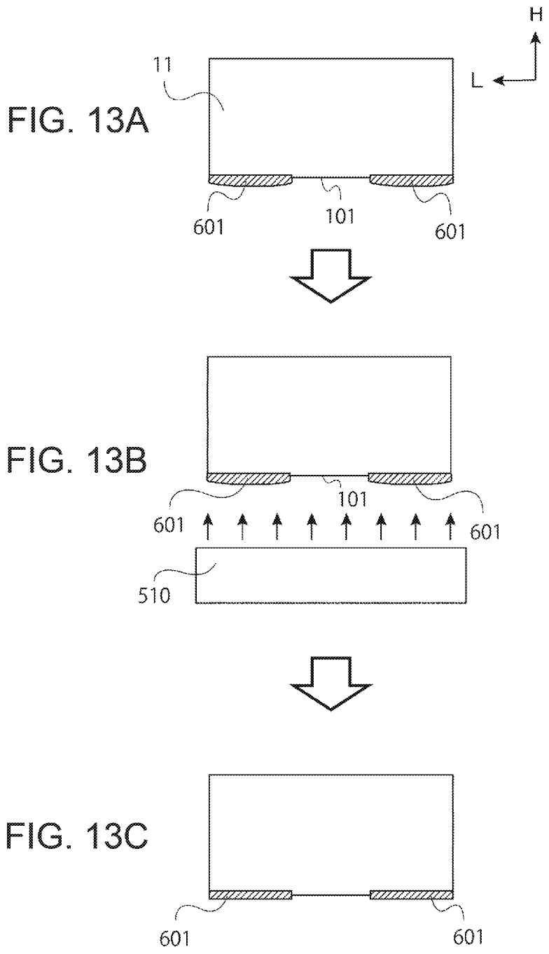

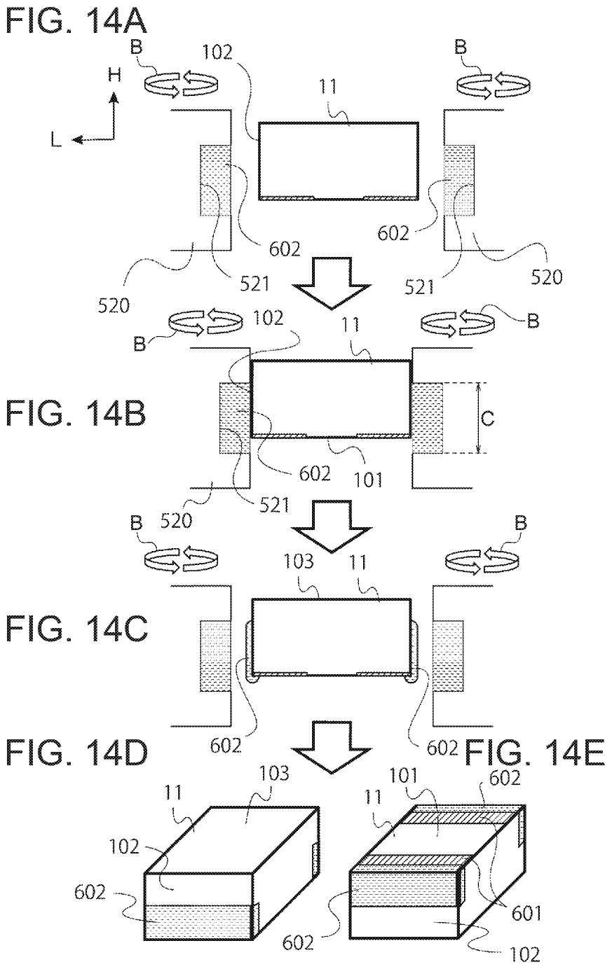

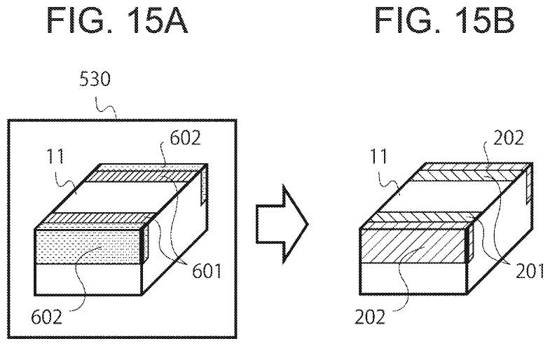

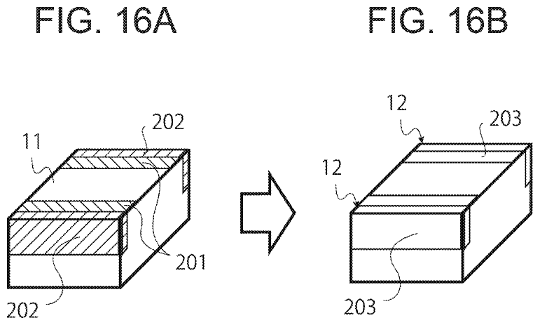

FIG. 13A to FIG. 13C, FIG. 14A to FIG. 14E, FIG. 15A to FIG. 15B, and FIG. 16A to FIG. 16B are diagrams showing the manufacturing steps of the external electrodes 12 of the coil component 1 shown in FIG. 1 to FIG. 5.

As shown in FIG. 13A, a first conductive paste 601 is applied to the bottom face 101 of the magnetic base body 11 at two positions, where lower ends of the lead portions 401 of the conductive member 14 are present, by screen printing, transfer, or the like. The first conductive paste 601 is a conductive paste containing, for example, 70% or more of a metal material.

Before the first conductive paste 601 is applied to the bottom face 101 of the magnetic base bodyll, an underlying electrode layer may be provided on the magnetic base body 11 by plating or sputtering. If the underlying electrode layer is provided and the first conductive paste 601 is applied over the underlying electrode layer, the thickness of the first conductive paste 601 may be reduced. This is because even if the thickness of the first conductive paste 601 is small, the third electrode layer 203 can be formed on the entire necessary portion in a subsequent process of forming the third electrode layer 203.

In this embodiment, the first conductive paste 601 applied to the bottom face 101 is planarized as shown in FIG. 13B. Specifically, a jig 510 is moved toward the bottom face 101 to press the first conductive paste 601 against the bottom face 101 such that the first conductive paste 601 is planarized.

As a result of the planarization of the first conductive paste 601, the first conductive paste 601 becomes two layers, each of which has a smooth surface and a small thickness, as shown in FIG. 13C.

After the layers of the first conductive paste 601 are formed on the bottom face 101, the second conductive paste 602 is applied to the base body 11 as shown in FIG. 14A to FIG. 14E. The second conductive paste 602 is a conductive paste containing, for example, 60% or less of a metal material.

In the process of applying the second conductive paste 602, two rotating rollers 520 are used to apply the second conductive paste 602 onto the two opposite end faces 102 of the magnetic base body 11. As shown in FIG. 14A, the two rollers 520 are arranged to face the two end faces 102 of the base body 11, respectively. Each of the rollers 502 rotates as indicated by unshaded arrows B. A circumferential surface (outer surface) of each of the rollers 520 has a groove 521 that extends in the circumferential direction of the roller 520. The groove 521 is filled with the second conductive paste 602. The two rollers 520 can move toward the two end faces 102 of the base body 11 and contact the two end faces 102 of the base body 11, respectively (will be described with reference to FIG. 14B).

As shown in FIG. 14B, the rollers 520 move toward the base body 11 such that the circumferential surface of each of the rollers 520 is in contact with the corresponding end face 102 of the magnetic base body 11, and the second conductive paste 602 in the groove 521 is applied to the end face 102 of the magnetic base body 11. At this time, the position of each of the rollers 520 in the height direction H is adjusted such that the edge of the groove 521 of each roller 520 is in contact with the middle of the end face 102 and the ridge between the bottom face 101 and the end face 102 is located within the width C of the groove 521.

As the positions of the rollers 520 are adjusted in the above-described manner, the second conductive paste 602 is applied at a position away from the upper face 103 of the magnetic base body 11, as shown in FIG. 14C. The coating width of the second conductive paste 602 in the height direction H is accurately controlled by the edge of the groove 521. The moon shape of the second conductive paste 602 is generated on the bottom face 101 of the magnetic base body 11, but has little influence on the dimensional accuracy of the coating width of the second conductive paste 602 in the height direction H.

By carrying out the paste application processes to the base body 11 as shown in FIG. 13A to FIG. 13C and FIG. 14A to FIG. 14C, the base body 11 has the conductive pastes 601 and 602 applied onto the bottom face 101 and the end faces 102, as shown in FIG. 14D and FIG. 14E. FIG. 14D is a perspective view of the base body 11 when viewed from the top, and FIG. 14E is a perspective view of the base body 11 when viewed from the bottom.

The magnetic base body 11 onto which the conductive pastes 601 and 602 are applied is placed in a heater (furnace) 530 as shown in FIG. 15A, and undergoes a sintering process. As the conductive pastes 601 and 602 are sintered, the first electrode layer 201 and the second electrode layer 202 are formed on the base body 11, as shown in FIG. 15B.

Thereafter, as shown in FIG. 16A and FIG. 16B, the third electrode layers 203 are formed by, for example, plating, coating of a metallic material, sputtering, or vapor deposition, so as to cover the two pairs of the first electrode layer 201 and the second electrode layer 202 formed on the magnetic base body 11, respectively, thereby forming the external electrodes 12 on the base body 11.

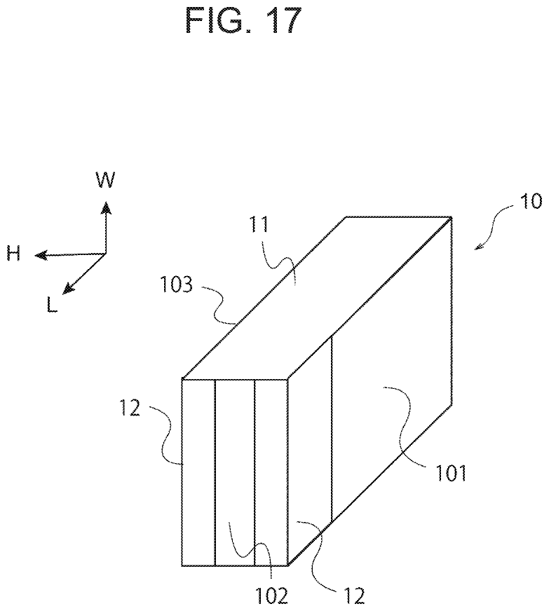

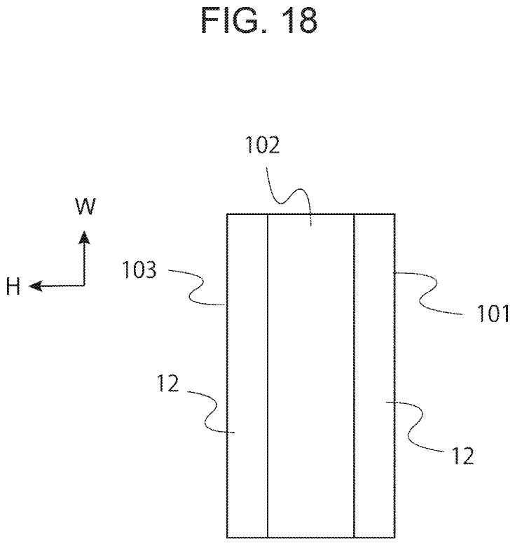

A modification to the coil component 1 will be described with reference to FIG. 17 and FIG. 18. FIG. 17 is a perspective view of a coil component 10 having a modified structure, and FIG. 18 is an enlarged view of an end face of the coil component 10 shown in FIG. 17.

In the coil component 10 of FIG. 17, one external electrode (lower external electrode) 12 is provided over one of the two end faces 102 and the bottom face 101 of the magnetic base body 11, and another external electrode (upper external electrode) 12 is provided over the same end face 102 and the top face 103 of the magnetic base body 11. When the coil component 10 is mounted on the board 2a, the end face 102 of the coil component 10 on which the two external electrodes 12 are formed faces the board 2a.

Each of the external electrodes 12 of the coil component 10 includes the first electrode layer 201, the second electrode layer 202, and the third electrode layer 203 in a similar configuration to the external electrode 12 shown in FIG. 5. However, the upper external electrode 12 of the coil component 10 has the first electrode layer 201 on the end face 102 of the magnetic base body 11, and the second electrode layer 202 on the top face 103, and the lower external electrode 12 of the coil component 10 has the first electrode layer 201 on the end face 102, and the second electrode layer 202 on the bottom face 103.

Further, in the coil component 10, the first conductive paste 601, which will become the first electrode layers 201, is applied onto two areas of the sole end face 102 of the magnetic base body 11 by paste application carried out by one of the rollers 520 shown in FIG. 14B. By this paste application, the two first electrode layers 201 are formed in two narrow areas on the sole end face 102 with high accuracy.

### Tests to Actual Products

Here, actual products (samples) of the coil component 1 shown in FIGS. 1 to 5 will be described.

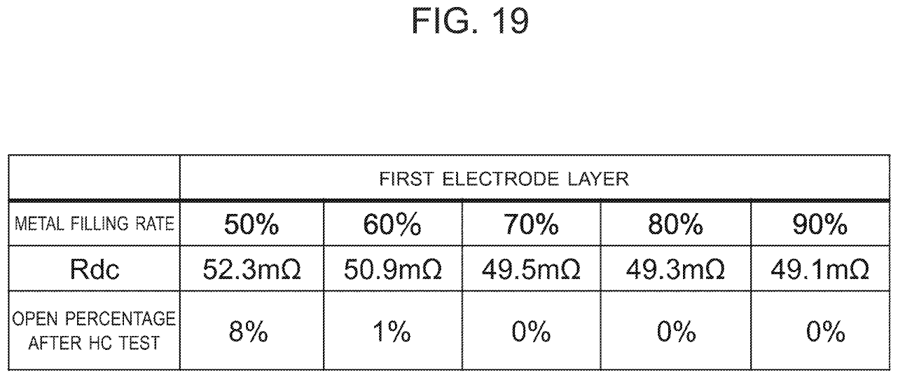

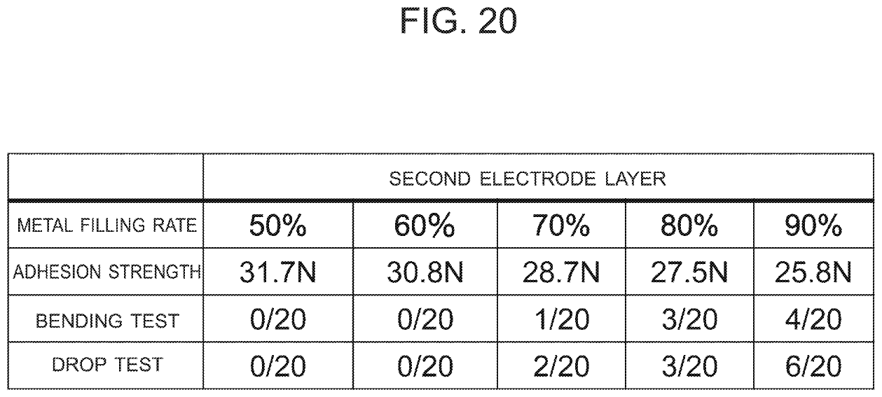

Electrical tests were performed on five kinds of samples in which the metal filling rates in the first electrode layer 201 were different from each other. FIG. 19 shows results of the electrical tests. Strength tests were performed on five kinds of samples in which the metal filling rates in the second electrode layer 202 were different from each other. FIG. 20 shows results of the strength tests.

Referring to FIG. 19, the results of the electrical tests will be described.

In order to adjust (change) the metal filling rate in the first electrode layer 201, five types of first conductive pastes having different contents of the metal material were used as the first conductive pastes that eventually became the first electrode layers 201. A measuring test of DC resistance Rdc and a high-load (Heat Cycle) test were carried out, as the electrical tests.

The first row of the table of FIG. 19 shows the metal filling rate of the first electrode layer 201 in each sample. The second row of the table of FIG. 19 shows the measured value Rdc of DC resistance. The third row of the table of FIG. 19 shows the occurrence rate (%) of open (disconnected) state after the high-load (HC) test.

The measured value of DC resistance Rdc indicates a lower value as the metal filling rate of the first electrode layer 201 is higher. The occurrence rate (%) of open state after the HC test was 0% when the metal filling rate of the first electrode layer 201 was 70% or more. Therefore, from the results of the electrical tests, it can be said that the metal filling rate of the first electrode layer 201 is preferably 70% or more.

FIG. 20 is a table showing the results of the strength test for five kinds of samples in which the metal filling rates of the second electrode layer 202 are different. Twenty samples were prepared for each kind of sample.

In order to adjust (change) the metal filling rate in the second electrode layer 202, a plurality of types of second conductive pastes having different contents of the metal material were used as the second conductive pastes that eventually became the second electrode layers 202. An adhesion strength test, a flexural test, and a drop test were carried out as the strength tests. The adhesion strength test measures the adhesion force of the coil component 1 to the board 2a. The flexural strength test confirms the occurrence of cracks in the coil component 1 upon bending the board 2a. The drop test confirms the falling of the coil component 1 from the board 2a upon dropping the circuit board arrangement 2 from a certain height.

The first row of the table of FIG. 20 shows the metal filling rate of the second electrode layer 202 in each group of samples. The second row of the table of FIG. 20 shows an average of the measurement values of the adhesion strength. The third row of the table of FIG. 20 shows the ratio of occurrence of cracks and the like caused by the flexural strength test for the twenty samples as fractions. For example, 0/20 indicates that cracking occurred in none of the twenty samples, and 1/20 indicates that cracking occurred in one of the twenty samples. The fourth row of the table of FIG. 20 shows the ratio of the falling of the coil component from the board caused by the drop test for the twenty samples in the form of fraction.

When the metallic filling rate of the second electrode layers 202 was 60% or less, the adhesion strength showed a high value (i.e., higher than 30N), no cracking occurred in the twenty samples, and no dissociation of the coil component 1 occurred in the twenty samples. Therefore, it can be said that the metal filling rate of the second electrode layer 202 is preferably 60 or less. If the results of FIG. 19 are also taken into account (i.e., the metal filling rate of 70% or more is desirable in the first electrode layer 201), the following is confirmed, i.e., if the metal filling rate of the second electrode layer 202 is lower than the metal filling rate of the first electrode layer 201, both the relaxation of stress exerted on the external electrodes 12 and the low resistance value can be achieved.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed:

1. A coil component comprising:
a magnetic base body formed by bonding metal magnetic particles, the magnetic base body having a first face and a second face that is immediately adjacent to the first face;
a conductor provided inside and/or on a surface of the magnetic base body; and
an external electrode electrically connected to the conductor and including a first electrode layer, a second electrode layer, and a third electrode layer,
wherein the first electrode layer contains a metal material at a first metal filling rate and is provided in a first predetermined area of the first face closer to the second face than to a face of the magnetic base body immediately adjacent to the first face and opposite to the second face,
the second electrode layer is provided in a second predetermined area of the second face closer to the first face than to a face of the magnetic base body immediately adjacent to the second face and opposite to the first face, said second electrode layer containing a metal material at a second metal filling rate lower than that the first metal filling rate of the first electrode layer, and
the third electrode layer is configured to cover an outer surface of the first electrode layer and an outer surface of the second electrode layer, and extends over and in contact with the first predetermined area of the first face and the second predetermined area of the second face of the magnetic base body.

2. The coil component according to claim 1, wherein the first face of the magnetic base body faces a board when the coil component is mounted on the board.

3. The coil component according to claim 1, wherein when an imaginary line is defined along an interface between the first face and the second face, the second electrode layer has a smaller dimension in a direction parallel to the imaginary line than in a direction perpendicular to the first face.

4. The coil component according to claim 1, wherein a portion of the second electrode layer overlaps a portion of the first electrode layer on the first face.

5. The coil component according to claim 1, wherein an end of the conductor is connected to the first electrode layer such that the conductor is electrically connected to the external electrode.

6. The coil component according to claim 1, wherein the second electrode layer has a metal filling rate of 60% or less.

7. The coil component according to claim 1, wherein the first electrode layer has a metal filling rate of 70% or more.

8. A circuit board arrangement comprising:
a coil component recited in claim 1; and
a board on which the coil component is mounted.

9. An electronic device comprising a circuit board arrangement recited in claim 8.

10. A method of manufacturing the coil component recited in claim 1, comprising steps of:
applying a first conductive paste, which contains a metal material and a non-metal material, on the first predetermined area of the first face of the magnetic base body;
applying a second conductive paste, which contains a metal material and a non-metal material and has a metal filling rate higher than that of the first conductive paste, on the second predetermined area of the second face of the magnetic base body;
sintering the first conductive paste and the second conductive paste to form the first electrode layer having the first metal filling rate and the second electrode layer having the second metal filling rate, respectively; and
forming the third electrode layer covering the first electrode layer and the second electrode layer.

11. The method of manufacturing a coil component according to claim 10, further comprising planarizing the first conductive paste applied to the first face by applying a pressure toward the first face.

12. The method of manufacturing a coil component according to claim 10, wherein said the step of forming the third electrode layer includes forming the third electrode layer by plating.
